(19) United States
(12) Patent Application Publication
(10) Pub. No.: US 2013/0037739 A1
(43) Pub. Date: Feb. 14, 2013

(54) DRIPFREE GASOLINE NOZZLE

(71) Applicant: Matthew David Millard, La Jolla, CA (US)

(72) Inventor: Matthew David Millard, La Jolla, CA (US)

(21) Appl. No.: 13/207,596

(22) Filed: Aug. 11, 2011

(51) Int. Cl. F16K 1/00

(52) U.S. Cl. 251/337

(57) ABSTRACT

A device for reducing drips from a nozzle comprising a valve body comprising a frusto-conical outer surface, a first aperture that receives the stem of a movable valve closure mechanism, and one or more additional apertures that allow fluids to flow through the valve body when the valve is opened. In an exemplary embodiment of the invention, the spring biased movable valve closure mechanism comprises a stem extending in the direction of the longitudinal axis of the valve body, a frusto-conical valve head that maintains a fluid barrier seal with the outer surface, and a spring that biases the valve closure mechanism in the direction of the longitudinal axis of the valve body.

### BACKGROUND OF THE INVENTION

1. Field of the Invention

The invention relates generally to the field of gasoline nozzles. In particular, the invention relates to a method and system for reducing or eliminating spillage from gasoline nozzles.

2. Description of Related Art

The problem of reducing or eliminating fuel loss related to dripping from gasoline dispenser nozzles has long been recognized, but a cost effective system and method for eliminating drips has proven elusive. Vehicle refueling using existing gasoline nozzle designs results in gasoline vapor and spillage losses through drips from the nozzle, particularly after nozzle shutoff as the device is removed from the fueling port. Gasoline is high in volatile organic compounds (VOCs) and hazardous air pollutants (HAPs), both of which are targeted for reduction/elimination by environmental regulations. It is estimated that such spillage emissions account for 6% or more of vehicle refueling emissions. Thus, a reduction or elimination of vehicle refueling spillage, and in particular elimination of residual fuel drips, will significantly reduce vehicle refueling losses and emissions.

Existing systems for reducing or eliminating fuel drips are mechanically complex, fail to provide a universal solution that can be applied as a retrofit or incorporated into a wide range of commercially available nozzles, are not physically robust, and/or have proven to be costly to adopt. The present invention overcomes these problems, providing a method and system for eliminating or reducing drips and other spillage from gasoline nozzles that is robust, cost effective, and applicable across a broad range of commercially available nozzles.

### SUMMARY OF THE INVENTION

A device for reducing drips from a nozzle comprising a valve body with a frusto-conical outer surface, a first aperture that receives the stem of a movable valve closure mechanism, and one or more additional apertures that allow fluids to flow through the valve body when the valve is opened, and a spring biased valve closure mechanism comprising a stem extending in the direction of the longitudinal axis of the valve body, a frusto-conical valve head that maintains a fluid barrier seal with the frusto-conical outer surface, and a spring that biases the valve closure mechanism in the direction of the longitudinal axis of the valve body. In various embodiments, the frusto-conical valve head further comprises an annular groove of a size and dimension to receive an elastomeric o-ring, and the annular groove has a dovetail profile. In various embodiments the valve body, and/or the valve closure mechanism are made of stainless steel. In various embodiments, the device fits within the end of a standard gasoline nozzle and/or is affixed within the end of a standard gasoline nozzle.

### BRIEF DESCRIPTION OF THE DRAWINGS

FIG. 1A is a diagram showing a cut-away view of an exemplary embodiment of a dripfree nozzle in the closed position.

FIG. 1B is a diagram showing a cut-away view of an exemplary embodiment of a dripfree nozzle in the open position.

FIG. 1C is a diagram showing a cut-away exploded view of an exemplary embodiment of a dripfree nozzle.

FIG. 2A is a diagram showing a cut-away view of an exemplary embodiment of a dripfree nozzle in the closed position.

FIG. 2B is a diagram showing a cut-away view of an exemplary embodiment of a dripfree nozzle in the open position.

FIG. 2C is a diagram showing a section view of the body portion of an exemplary embodiment of a dripfree nozzle.

FIG. 2D is a diagram showing a cut-away exploded view of an exemplary embodiment of a dripfree nozzle.

FIG. 3 is a diagram showing a cut-away view of an exemplary embodiment of a dripfree nozzle in the closed position.

FIG. 4 is a diagram showing a cut-away view of an exemplary embodiment of a dripfree nozzle in the closed position.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

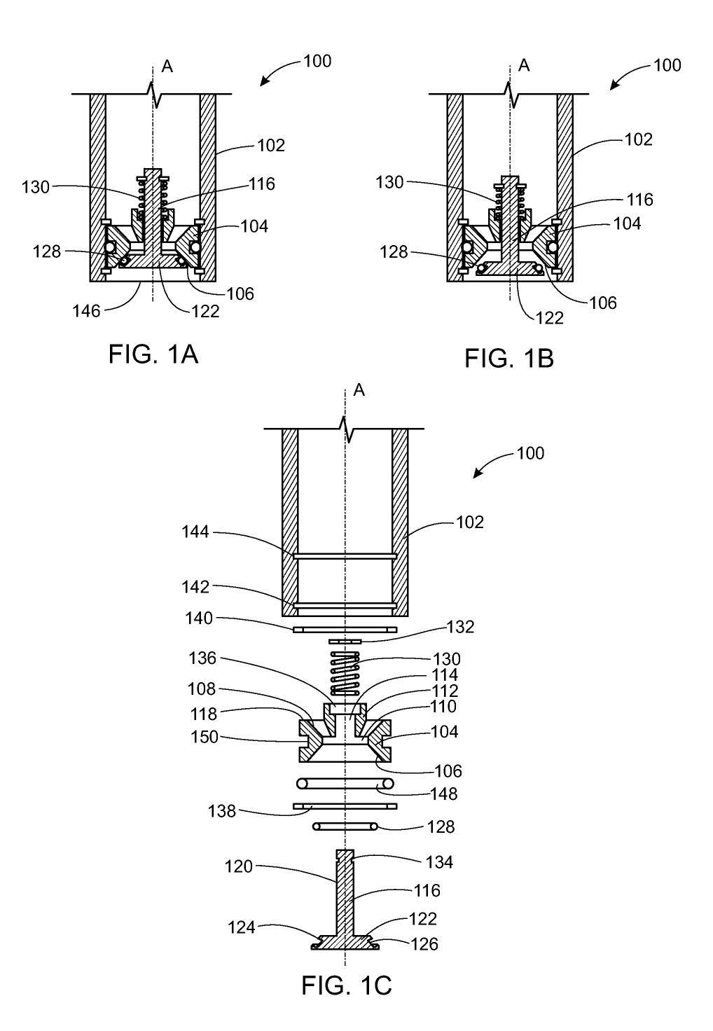

Referring to FIGS. 1A through 1C, an exemplary embodiment of a dripfree nozzle 100 is shown. The dripfree nozzle 100 is comprised of a gasoline nozzle 102 with a valve assembly affixed inside and near the opening of the nozzle 102. The body 104 of the valve assembly is a generally circular structure of a dimension and geometry that allows it to fit snugly within the gasoline nozzle 102. In an exemplary embodiment the body 104 has frusto-conical tapered outer and inner surfaces 106 and 108 generally centered on longitudinal axis A. In alternative exemplary embodiments inner surface 108 may have a different shape such as a cylinder, or may be minimized.

The body 104 has an aperture 110 or bore generally centered on longitudinal axis A and of a dimension and geometry to allow free flow of the gasoline or other fluid through the nozzle when the valve is open. The body 104 also has a guide structure 112 with a second aperture 114 generally centered on longitudinal axis A to guide and constrain the movement of the closure mechanism 116. The guide structure 112 may be integral to the body 104 or permanently affixed to the body 104 by means of a flange or web structure extending from inner annular surface 118.

In an exemplary embodiment, the closure mechanism 116 comprises a stem 120 and a head 122. The head 122 has a frusto-conical mating surface 124 with an annular groove 126 of a dimension and geometry to receive a first elastomeric o-ring 128. In an exemplary embodiment, annular groove 126 may have a profile such as a dovetail to improve the o-ring retention in high-flow environments. The mating surface 124 has a dimension and geometry that matches the dimension and geometry of tapered outer surface 106 and the closure mechanism 116 is positioned such that when the mating surface 124 of head 122 is drawn into contact with tapered outer surface 106 a tight seal is formed that will prevent fluid flow through first aperture 110.

The stem 120 of closure mechanism 116 extends longitudinally through second aperture 114 and is held in position by biasing spring 130 and clip 132 which seats in second annular groove 134. In an exemplary embodiment biasing spring 130 is a coil spring that fits over stem 120, rests within a recess 136 in guide structure 112, and is biased against clip 132. The complete valve assembly comprising the fully assembled body 104, guide structure 112, and closure mechanism 116 is then affixed within a gasoline nozzle 102 by any appropriate means, including both permanent means such as welding and removable means such as clips or other fasteners.

In an exemplary embodiment, the valve assembly is removably affixed within a gasoline nozzle 102 near the discharge opening by means of two annular clips 138 and 140 that seat within annular grooves 142 and 144 that are disposed within the nozzle 102 at positions immediately inside and outside the body 104 to hold it firmly in place. One or more elastomeric o-rings 148 may be seated in one or more annular rings 150 located on the outer perimeter of the body 104 to maintain a fluid seal between the valve assembly and the inner surface of the nozzle 102.

Referring to FIG. 1A, when the nozzle 102 is not in operation, closure mechanism 116 is biased against outer tapered surface 106 and the valve assembly is closed such that no residual fluids in the nozzle can pass through the nozzle opening 146. Referring to FIG. 1B, when the nozzle 102 is turned on, the fluid pressure against the head 122 overcomes the axial force of biasing spring 130, forcing the head 122 away from outer tapered surface 106 and allowing fluid flow through the valve assembly. Thus, operation of the valve assembly is controlled by the fluid pressure within the nozzle 102 such that the valve assembly closes automatically when the fluid pressure drops below a level sufficient to overcome the bias of biasing spring 130, preventing fluid loss through drips or other residual discharge.

The exemplary valve assemblies described herein can be placed anywhere within the nozzle 102, but placement near the nozzle opening 146 will often be suitable to minimize the loss of residual fluids in the nozzle and eliminate any interference with other nozzle components. As noted above, it will be understood by those skilled in the art that the valve assembly can be permanently or removably affixed within the nozzle 102 by any means or structure suitable to the design of the nozzle 102 and the fluid that is being dispensed.

While reference is made extensively herein to the use of such valve assembly in a gasoline dispensing nozzle, the invention is suitable for use on any type of fluid dispensing nozzle where elimination of residual discharge has value, including without limitation dispensers of diesel, aircraft fuels, and other petroleum distillates, and all other types of fluids that are valuable and/or present risks to human health or the environment with discharge to the ground or atmosphere.

Materials used in the valve assembly can vary widely but should be suitable to the particular application in which they are applied. In exemplary embodiments directed to use with gasoline dispensing nozzles, all of the structural components including the body 104, guide structure 112, closure mechanism 116, biasing spring 130, and all clips may be made of stainless steel, while any o-rings or other elastomeric components may be made from a fluoro-polymer or other material designed to retain its design characteristics while in constant contact with gasoline or under harsh, oxidizing environments.

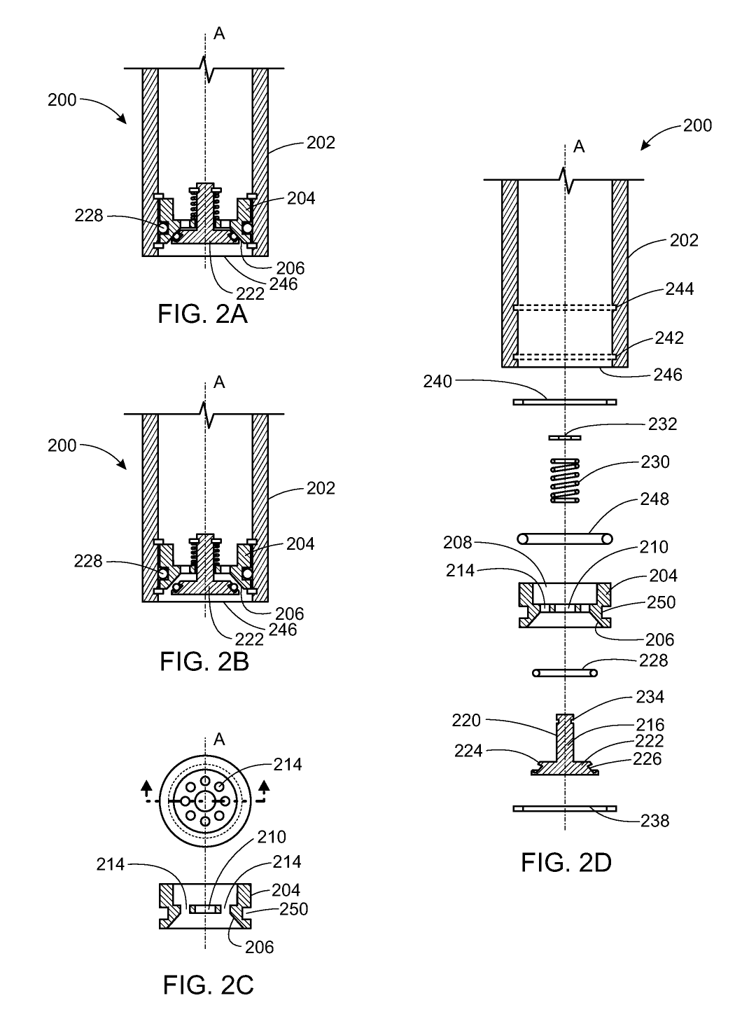

Referring to FIGS. 2A through 2D an exemplary embodiment of a dripfree nozzle 200 with a shortened overall valve length is shown. The dripfree nozzle 200 is comprised of a gasoline nozzle 202 with a valve assembly affixed inside and near the opening of the nozzle 202. The body 204 of the valve assembly is a generally circular structure of a dimension and geometry to allow it to fit snugly within the gasoline nozzle 202. In an exemplary embodiment the body 204 has a frusto-conical tapered outer surface 206 and a generally cylindrical inner cavity 208 generally centered on longitudinal axis A.

The body 204 has a central aperture 210 or bore generally centered on longitudinal axis A to guide and constrain the movement of the closure mechanism 216. The body 204 also has a plurality of additional apertures a 214 through the structure surrounding the central aperture 210 of a dimension and geometry to allow free flow of the gasoline or other fluid through the nozzle when the valve is open.

In an exemplary embodiment, the closure mechanism 216 comprises a stem 220 and a head 222. The head 222 has a frusto-conical mating surface 224 with an annular groove 226 of a dimension and geometry to receive a first elastomeric o-ring 228. In an exemplary embodiment, annular groove 226 may have a profile such as a dovetail to improve the o-ring retention in high-flow environments. The mating surface 224 has a dimension and geometry that matches the dimension and geometry of tapered outer surface 206 and the closure mechanism 216 is positioned such that when the mating surface 224 of head 222 is drawn into contact with tapered outer surface 206 a tight seal is formed that will prevent fluid flow through the body 204.

The stem 220 of closure mechanism 216 extends longitudinally through central aperture 210 and is held in position by biasing spring 230 and clip 232 which seats in second annular groove 234. In an exemplary embodiment biasing spring 230 is a coil spring that fits over stem 220, rests within inner cavity 208, and is biased against clip 232. The complete valve assembly comprising the fully assembled body 204 and closure mechanism 216 is then affixed within a gasoline nozzle 202 by any appropriate means, including both permanent means such as welding and removable means such as clips or other fasteners. Stem 220 of closure mechanism 206 and valve body 204 are designed to extend the least possible depth along axis A to avoid interference with any internal components of the gasoline nozzle 102. Optimally, the valve will have a total length along axis A of approximately 10 mm or less.

In an exemplary embodiment, the valve assembly is removably affixed within a gasoline nozzle 202 near the discharge opening by means of two annular clips 238 and 240 that seat within annular grooves 242 and 244 that are disposed within the nozzle 202 at positions immediately inside and outside the body 204 to hold it firmly in place. One or more elastomeric o-rings 248 may be seated in one or more annular rings 250 located on the outer perimeter of the body 204 to maintain a fluid seal between the valve assembly and the inner surface of the nozzle 202.

Referring to FIG. 2A, when the nozzle 202 is not in operation, closure mechanism 216 is biased against outer tapered surface 206 and the valve assembly is closed such no residual fluids in the nozzle can pass through the nozzle opening 246. Referring to FIG. 2B, when the nozzle 202 is turned on, the fluid pressure against the head 222 overcomes the axial force of biasing spring 230, forcing the head 222 away from outer tapered surface 206 and allowing fluid flow through the valve assembly. Thus, operation of the valve assembly is controlled by the fluid pressure within the nozzle 202 such that the valve assembly closes automatically when the fluid pressure drops below a level sufficient to overcome the bias of biasing spring 230, preventing fluid loss through drips or other residual discharge.

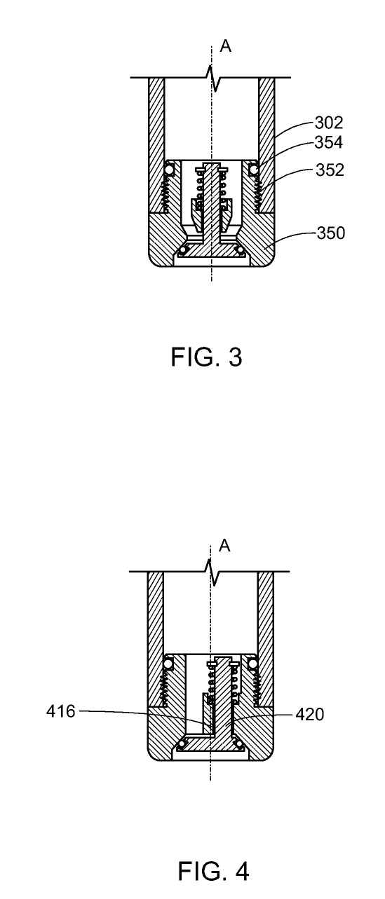

Referring to FIG. 3, in an alternate embodiment the valve assembly is integrated into a nozzle tip 350, which can be inserted into nozzle 302 and held in place by threads 352 or any other suitable attachment system. An o-ring 354 or other suitable device can be used to prevent leakage through the threads 352.

Referring to FIG. 4, in an alternate embodiment the stem 420 of closure mechanism 416 is offset from longitudinal axis A to allow for use with different types of nozzles to avoid obstructions, or to manage the fluid flow when the valve is in the open position.

While reference is made herein to a gasoline nozzle, it will be understood that the invention disclosed herein can be easily adapted for use with a wide range of nozzles for dispensing various types of fluids where the prevention or elimination of drips is beneficial. As indicated above, materials used in the various embodiments herein can vary widely but should be suitable to the particular application in which they are applied. In exemplary embodiments directed to use with gasoline dispensing nozzles, all of the structural components may be made of stainless steel, while any o-rings or other elastomeric components may be made from a fluoro-polymer or other material designed to retain its integrity and design characteristics while in constant contact with gasoline or under harsh, oxidizing environments.

What is claimed is:

1. A device for reducing drips from a nozzle comprising:
a valve body comprising a frusto-conical outer surface; a first aperture that receives the stem of a movable valve closure mechanism; and one or more additional apertures that allow fluids to flow through the valve body when the valve is opened; and
a spring biased valve closure mechanism comprising a stem extending in the direction of the longitudinal axis of the valve body, a frusto-conical valve head that maintains a fluid barrier seal with the frusto-conical outer surface, and a spring that biases the valve closure mechanism in the direction of the longitudinal axis of the valve body.

2. The device of claim 1, wherein the frusto-conical valve head further comprises an annular groove of a size and dimension to receive an elastomeric o-ring.

3. The device of claim 2, wherein the annular groove has a dovetail profile.

4. The device of claim 1, wherein the valve body is made of stainless steel.

5. The device of claim 1, wherein the valve closure mechanism is made of stainless steel.

6. The device of claim 1, wherein the device fits within the end of a standard gasoline nozzle.

7. The device of claim 6, wherein the device is affixed within the end of a standard gasoline nozzle.

8. The device of claim 1, wherein the stem is aligned with the longitudinal axis of the valve body.

9. The device of claim 1, wherein the stem is not aligned with the longitudinal axis of the valve body.
